(19) United States
(12) Patent Application Publication
(10) Pub. No.: US 2014/0346161 A1
(43) Pub. Date: Nov. 27, 2014

(54) Hair Iron Fume Removal Device

(71) Applicant: Nicholas Lloyd Johnson, Oakland, CA (US)

(72) Inventor: Nicholas Lloyd Johnson, Oakland, CA (US)

(21) Appl. No.: 14/457,016

(22) Filed: Aug. 11, 2014

Related U.S. Application Data
(63) Continuation of application No. 12/854,888, filed on Aug. 11, 2010.

(51) Int. Cl. A45D 44/02; B08B 15/04; A45D 1/04; A45D 2/00; A45D 1/06; A45D 7/06

(52) U.S. Cl. CPC A45D 44/02; A45D 1/06; A45D 7/06; A45D 1/04; A45D 2/001; B08B 15/04; A45D 2001/002
USPC 219/225

(57) ABSTRACT

The problem of noxious fume generation during chemical treatment of hair using a hair iron is solved by providing a fume intake on the hair iron near the point of fume generation, preferably near the iron's heating elements. The fume intake receives the fumes and delivers them to the fume removal passage under vacuum flow generated by a vacuum source, then transported to a filtration system or exhausted to the outside environment. Optionally, the fume intake may extend along the length of the heating element and may be directed downward, towards the hair. Optionally, the fume removal device may be attachable as a retrofit to a standard hair iron. The present invention advantageously prevents the spread of the noxious fumes to the rest of the salon and protects both the stylist and client from discomfort and irritation, thus permitting the more widespread use of these beneficial hair treatments.

### RELATED APPLICATION DATA

This application is a continuation of co-pending non-provisional application Ser. No. 12/854,888 filed on Aug. 11, 2010, which in turn claims the priority date of provisional application No. 61/233,117 filed on Aug. 11, 2009.

### BACKGROUND OF THE INVENTION

1. Field of the Invention

The present invention relates to a fume removal device, and more particularly, to a fume removal device for use with a hair iron during the chemical treatment of hair.

2. Description of the Related Art

Hair straightening and conditioning procedures, such as procedures commonly known as Brazilian or Japanese hair treatments, are popular and costly beauty salon services. The treatments generally involve chemically treating the hair, followed by straightening with a high temperature flat iron. The primary problem is that many types of straightening treatments generate large amounts of noxious vapors volatilized by the heat of the flat iron. The moisture and chemicals present in the hair result in smoke, steam, and unpleasant odors. The resulting fumes may also be a health hazard, causing many salons to exclude the treatments from their services.

Hairdressers and beauty salons have attempted to solve this problem by opening windows, increasing ventilation, or using fans to redirect the fumes. This approach has met with little success. Oftentimes, the use of fans will aggravate the problem by rapidly spreading the odors throughout the entire retail space, exposing the workers and entire clientele to the smell. As a result, many customers may be dissuaded from entering the business.

Some salons have tried more traditional means to eliminate fumes by providing bulky fume ducts that are situated near or above the hair during treatments. These devices are large and unwieldy, and do not effectively address the fumes at the source of production, where the flat iron meets the hair. As a result, the client and the stylist may experience the unpleasant and noxious fumes; and some fumes may escape the station and into the rest of the salon.

What is needed and not provided by the existing art is a means to remove fumes during a hair treatment to prevent localized exposure to the client and stylist, as well as the remainder of the salon. What is also needed is a device that removes fumes while not interfering with the styling action and movement of the hair iron. What is further needed is a device that is not bulky, hard to move, or requires repositioning by a separate action throughout the styling process.

### OBJECTS OF THE INVENTION

It is an object of the present invention to provide an improved hair iron fume removal device that effectively removes fumes from the source of fume production and prevents the spread thereof;

It is a further object of the present invention to provide an improved hair iron fume removal device that does not hinder the movement of the stylists tools or obscure the hair; and

It is a further object of the present invention to provide an improved hair iron fume removal device that is compact and in the optimal position for effective fume removal.

These and other advantages and attainments of the present invention will become apparent to those skilled in the art upon a reading of the following detailed description when taken in conjunction with the drawings wherein there is shown and described an illustrative embodiment of the invention.

### SUMMARY OF THE INVENTION

A preferred embodiment of the present invention provides fume removal device connected to a hair iron and used in conjunction with a vacuum source during the application of a chemical treatment to the hair. The device includes at least one fume intake that is preferably near the heating element of the hair iron, since this is the source of the heat generated fumes. However, the fume intake may be formed or attached on any part of the hair iron near the point on fume generation. A fume removal passage permits fluid communication between the fume intake and the vacuum source. The fume intake draws in a substantial quantity of fumes through vacuum flow action as the hair iron is applied to the section of hair. The fume removal passage transports the fumes to a desired disposal location through a flexible tube.

The fume intake is preferably configured to create a vacuum flow over the much of the entire length of the heating element, preferably by an elongated slot. Although, if it is desired the fume intake may be placed intermittently along the length, just a portion thereof, or a region longer than the length.

The vacuum source may be adjustable to provide a rate of vacuum flow that matches the rate of fume production. The vacuum flow may also be directed to draw from a direction towards the hair. This is accomplished by directing the fume intake so that it faces the hair when the hair iron is applied to the hair. To direct the fume intake, a portion is designed to extend over the hair, extending beyond the edge of the hair iron.

### BRIEF DESCRIPTION OF THE SEVERAL VIEWS OF THE DRAWINGS

FIG. 1 is a side plan view of the preferred embodiment of the present invention, showing the fume intake and showing the internal fume removal passage in phantom with the jaws in the open mode;

FIG. 2A is a side plan view of the preferred embodiment of the present invention, showing the hair iron jaws in the closed mode;

FIG. 2B is a top plan view of the preferred embodiment of the present invention, showing the overhang of the fume removal device;

FIG. 2C is a sectional view of the preferred embodiment of the present invention, showing a configuration for the fume intake;

FIG. 2D is a sectional view of yet another preferred embodiment of the present invention, showing a second configuration for the fume intake;

FIGS. 3A-B are views of the preferred embodiment of the present invention as it is applied to the hair of a client;

FIG. 4 is a perspective view of the preferred embodiment of the present invention, showing two potential modes of exhausting the fumes; and

FIG. 5 is a sectional view of a kit of the present invention, showing the kit interior with hair iron and vacuum source.

### LISTING OF REFERENCE NUMERALS of FIRST-PREFERRED EMBODIMENT

| | |
|---|---|
| fume removal system | 20 |
| fume removal device | 22, 22′ |
| hair iron | 24 |
| heating element | 26 |
| overhang | 28, 28′ |
| fume intake | 30 |
| fumes | 32 |
| vacuum source | 34 |
| filtration system | 36 |
| filter | 38 |
| fume removal passage | 40 |
| exhaust | 42 |
| hair | 44 |
| heating element | 46 |
| strand section | 48 |
| extended portion | 50 |
| power cord | 52 |
| connector | 54 |
| upper jaw | 56 |
| lower jaw | 58 |
| release button | 60 |
| arrow | 62 |
| vacuum source | 64 |
| enclosure | 66 |
| user | 68 |
| client | 70 |
| arrow | 72 |
| cooling vent | 74 |
| tube | 76, 76′, 76″ |
| atmosphere | 78 |
| path | 80 |
| path | 82 |
| pump outlet tube | 84 |
| switch | 86 |
| outlet | 88 |
| roots | 90 |
| tips | 92 |
| lower chamber | 94 |
| upper chamber | 96 |
| length | L |

### DESCRIPTION OF THE PREFERRED EMBODIMENTS

The detailed descriptions set forth below in connection with the appended drawings are intended as a description of embodiments of the invention, and is not intended to represent the only forms in which the present invention may be constructed and/or utilized. The descriptions set forth the structure and the sequence of steps for constructing and operating the invention in connection with the illustrated embodiments. It is to be understood, however, that the same or equivalent structures and steps may be accomplished by different embodiments that are also intended to be encompassed within the spirit and scope of the invention.

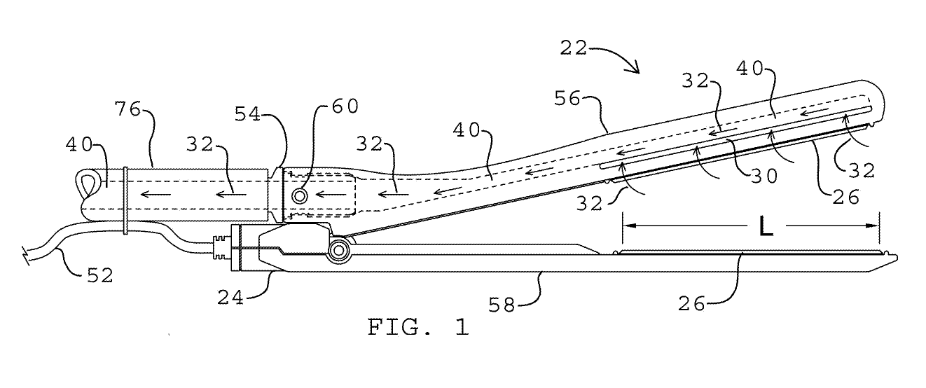

Turning first to FIG. 1, the fume removal device 22 of the present invention is shown as integrated and molded as part of a hair iron 24. In terms of the ironing function the hair iron 24, in this case a straightening or flat iron, is constructed of similar components to those used in standard hair irons used throughout the hair products industry and will therefore not be explained in great detail, since their function and structure are well known by those skilled in the art. The hair iron 24 has an upper jaw 56 that is pivoted to and rotates in relation to a lower jaw 58. The Jaws 56 and 58 may be injection molded with a plastic or similar material that is sufficiently heat resistant and has the required insulating qualities. The jaws 56 and 58 may be optionally unbiased or spring biased towards a normally open position or a normally closed position, where the angle between the jaws is near zero. On each of the mating surfaces of the jaws 56 and 58 a heating element 26 is provided, such as a ceramic coated PTC element or metal heating element. The flat, rectangular heating elements 26 are configured to meet in a substantially planar parallel relationship when the jaws 56 and 58 are closed. A power cord 52 provides power for the operation of the hair iron 24 and may be detachable from the hair iron 24 or integrated into the tube.

A preferred embodiment of the instant invention is shown in FIG. 1 integrated within the upper jaw 56 of the hair iron 24. Within the upper jaw 56 is formed a fume removal passage 40 that receives fumes 32 from the fume intake 30. In the preferred embodiment, the fume intake 30 is slot-shaped and proximate to at least one of the heating elements 26. Other fume intake 30 designs may be used with similar results as the slot, such as multiple orifices along the length L of the heating element 26, a single orifice with an overhang 28 design that guides the fumes 32 into the fume intake 30, or other designs within the scope of the invention that achieve similar results. The fume intake 30 is preferably located on the side of the hair iron 24 immediately adjacent to the position of a heating element 26 or on a region of the hair iron where fumes may be effectively collected, such as near the point of heat application upon the hair 44 strand section 48. The fume intake 30 may be of sufficient shape and/or size to have the capability of receiving fumes 32 (represented by the curved arrows leading into the fume intake 30) across the length L of the heating elements 26, a selected portion of the length L, or well beyond the length L.

In this exemplary embodiment, the fume removal passage 40 runs through the upper jaw 56 and delivers the fumes 32 to a tube 76 connected to the hair iron 24 through connector 54. A variety of connectors may be used, however a quick disconnect-type connector 54 may be preferred where a release button 60 or detent may be depressed to detach the hair iron 24 from the tube 76. The tube 76 may be selected from any type appropriate flexible tubing that permits the user 68 to freely utilize the hair iron 24 in a hairdressing procedure without substantial hindrance, but is substantially chemically resistant to the variety of fumes 32 produced and is substantially resistant to crimping or collapse due to vacuum pressure. Examples of appropriate tubing may include convoluted hose, braided or unbraided, or smooth-bored tubing. One specific example of a potentially appropriate tube selection may be ¾″ I.D. 1.05″ Nominal O.D. 0.020″ Wall Thickness. EH-L PVC Hose with External Polymer Helix, item no. 48930 from U.S. Plastic Corp.

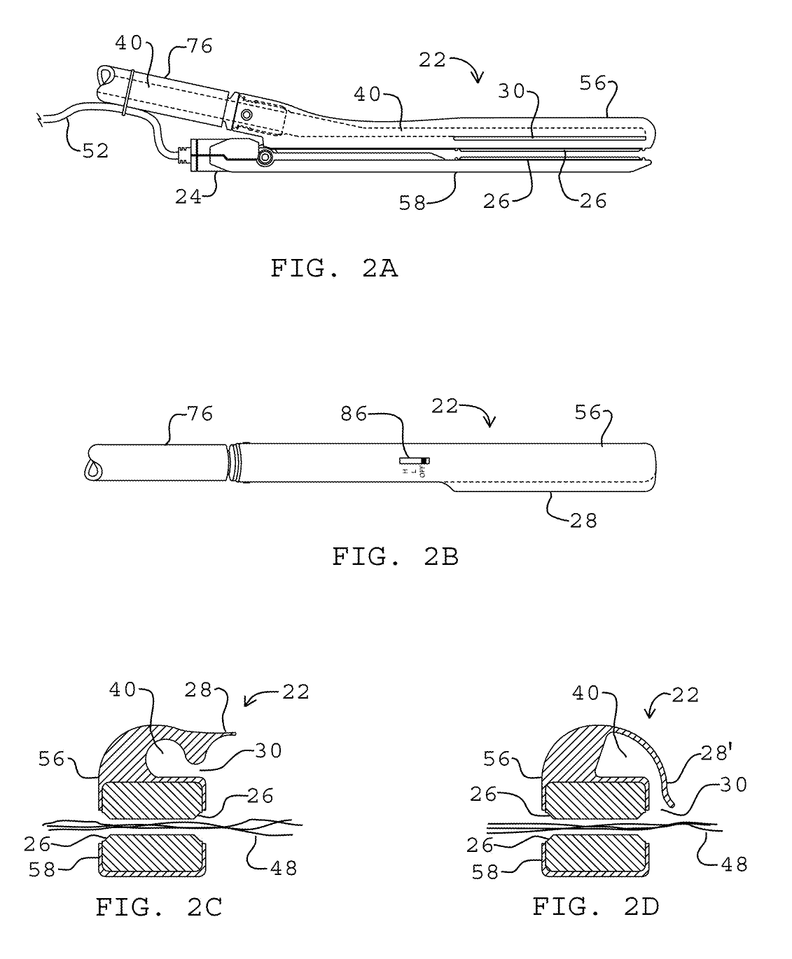

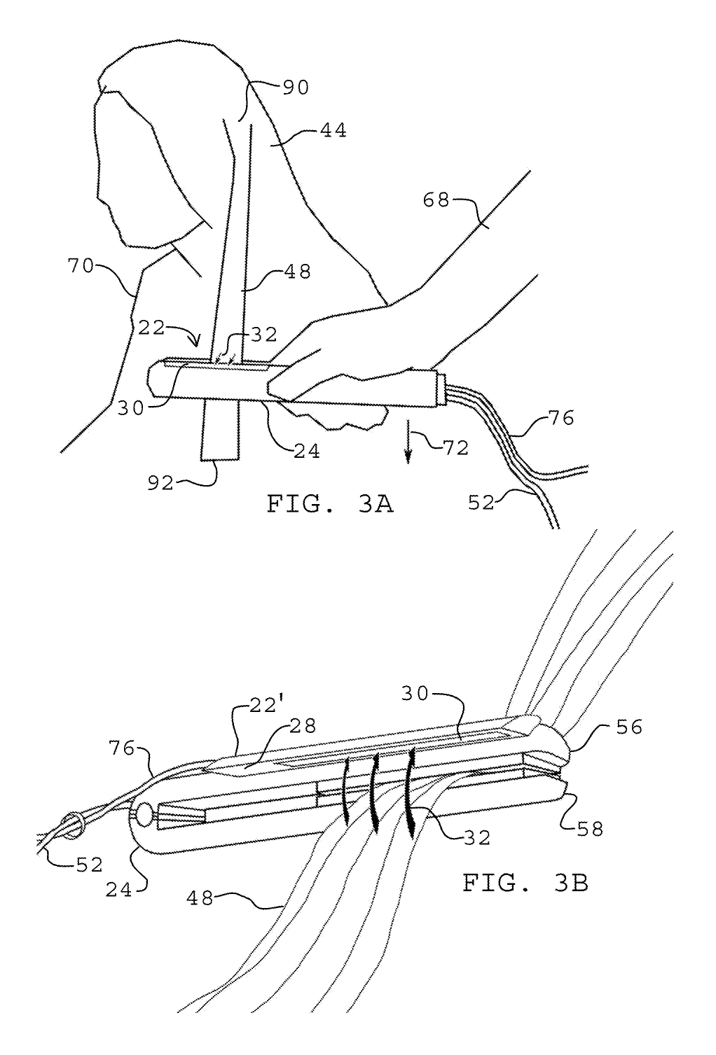

FIGS. 2A-D shows the hair iron 24 of the present invention in the closed mode where a strand section 48 of hair 44 may be interposed between the heating elements 26 in a hair treatment process. The hair iron 24 is usually applied to a strand section 48 near the roots and is drawn outwards towards the tips of the hair 44, affecting the structure of the strands 48 as heat and pressure is applied. The structural effect being determined by factors such as heating element shape and temperature and type of chemical applied to the hair. Switch 86 controls the temperature of the heating elements 26. The fumes 32 are created by the volatilization of chemicals which were applied to the hair 44, such as in a formaldehyde-based chemical treatment. FIGS. 2B-D show an overhang 28 extending beyond the edges of the hair iron 24 structure such that the overhang 28 extends directly over the strand section 48 to create a laboratory hood-like effect, to guide the rising fumes 32 into the fume intake 30 and to direct the vacuum flow across the strand section 48 and into the fume intake 30.

Two of the many possible configurations for the overhang 28 are shown in FIGS. 2C and 2D. In FIG. 2C, the fume intake 30 is directed to draw in fumes 32 from a direction approximately parallel to the strand section 48 clamped therebetween. As the hair iron 24 is drawn down the strand section 48 the overhang 28 tends to capture the upward rise of the fumes 32 from the strand section 48 and permit the fume intake 30 to draw in the fumes 30. The vacuum action in itself would serve to draw in a substantial quantity of fumes 32, even without the overhang 28. However, it has been found that the efficiency of fume 32 removal is increased with the presence of an overhang 28. After the fumes 32 have been guided into the fume intake 30, the fume removal passage 40 receives the fumes 32 and guides them through the tube 76. FIG. 2D shows an alternate embodiment of the overhang 28′, where the fume intake 30 is directed to draw in fumes 32 from a direction approximately perpendicular to the strand section 48 clamped therebetween. The overhang 28′ folds over the side of the hair iron 24 separated from the side by a gap that forms the fume intake 30. In a similar manner as described above, the fumes 32 are guided into the fume removal passage 40. It may be necessary to mold the upper jaw 56 in multiple sections to achieve the desired profile.

A preferred method of operation of the present invention can be viewed in FIG. 3A, where a user 68, such as a hair stylist, has the hair iron 24 with the fume removal device 22 of the present invention integrated thereon applied to the strand section 48 of a client 70. Arrow 72 shows the downward draw of the hair iron 24 from the roots 90 to the tips 92 of the hair 44. A chemical treatment is applied to the entire length or portion of the strand section 48. The heating elements 46 apply heat to the portion of air 44 directly in contact with the heating elements 46, thereby volatilizing the chemical to create fumes 32. In this example, the majority of the fumes 32 are released immediately next to the hair iron 24 on the upstream side of the strand section 48, where the direction of the hair iron 24 draw is considered the downstream direction. So, the fumes 32 are mostly released on the portions of the strand section 48 that are in immediate contact with the heating elements 26 or just exiting the hair iron 24. It can be seen that the fume intake 30 is on this upstream side of the hair iron 24 to capture and draw in the generated fumes 32. However, the fume intake 30 may be positioned on the downstream side and/or the upstream side of the hair iron 24 if required by the generation of fumes 32.

FIG. 3B shows a magnified view of the method of use with the detachable/attachable version of the fume removal device 22′ mounted to a standard hair iron 24 with permanent attachment means (adhesive, fasteners, and such) or removable attachment means (weak adhesive, hook and loop, and such). The fume removal device 22′ has been mounted to the side of the upper jaw 56, although other attachment points are conceived. The fume intake 30 is directed downwards, towards the strand section 48 and the side mounting provides an overhang 28. So, instead of the fume removal passage 40 and fume intake 30 being formed integrally with the upper jaw 56 or lower jaw 58 of the hair iron 24, the fume removal device 22′ is manufactured separately and is attached as a retrofit to a standard hair iron 24, so that the user 68 may modify an existing hair iron 24 or even choose to detach the fume removal device 22′ when the hair iron 24 is not being used in a chemical treatment process.

A preferred embodiment of the fume removal system 20 of the present invention is shown in FIG. 4. The fume removal device 22 is mounted to a hair iron 24, with the power cord 52 ready to be inserted into outlet 88 to provide power to the hair iron 24 and additionally to the vacuum source 64 located within enclosure 66. The vacuum source 64 may be selected from the numerous appropriate and readily available vacuum pumps and the like, such as an oil-free electric vacuum pump. The vacuum source 64 is preferably compact in size and of a manageable weight, although a permanently install vacuum pump may not be required to meet this criteria. Other vacuum sources 64 are also possible, such as a fan-based vacuum system and any other source that produces the required vacuum flow.

FIG. 4 further shows the two paths 80 or 82 by which the fumes 32 may be carried away from the hair 44. The fumes 32 may be carried through path 82 to tube 76″ and filtered through filter 36 mounted on the exhaust side of the vacuum source 64. The filter 36 is preferably selected to eliminate the specific type of fumes 32 generated. With formaldehyde, for example, a filter media with activated carbon, activated alumina/potassium permanganate, and/or potassium iodide may be selected. Or alternatively, a filter that utilizes a photocatalytic oxidation process may also be appropriate.

Alternately the fumes 32 may be carried through path 80, into tube 76′, through the vacuum source 64 in enclosure 66, and thereafter vented to atmosphere 78 at a remote location, such as through a window or vent leading to the outdoors. The tubes 76′ and 76″ are separate examples of the potential exhausting of the fumes 32, where the user 68 may select one at the exclusion of the other. So, the tube 76 is preferably continuous, with the continuing portion being either tube 76′ or 76″.

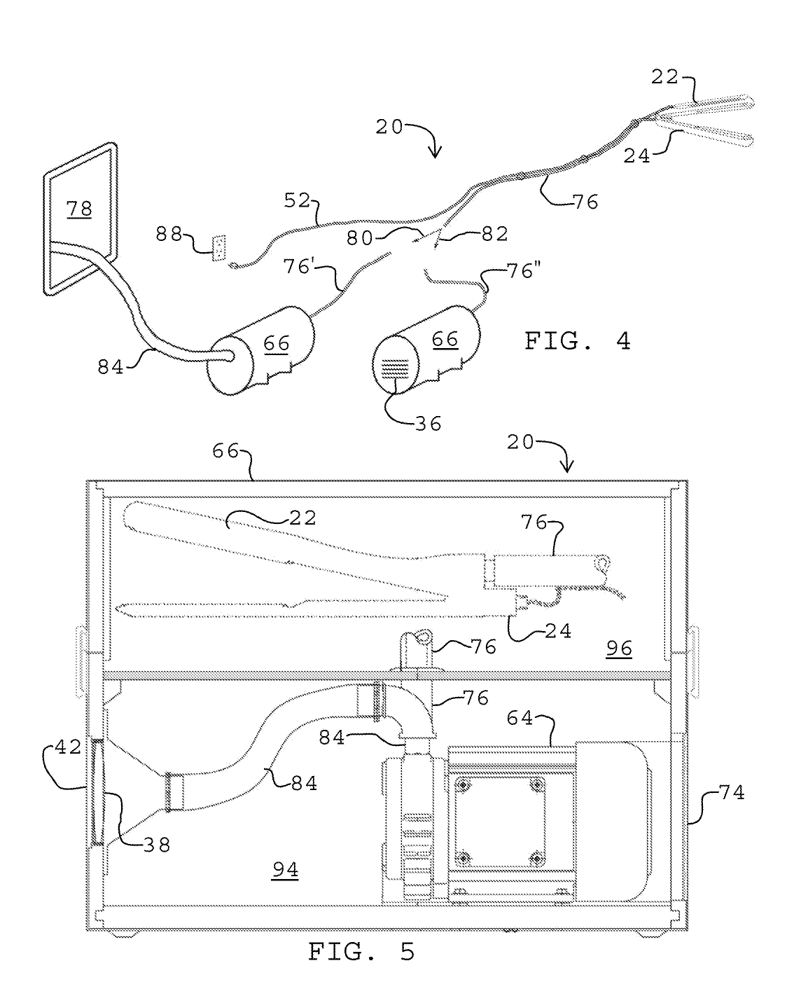

Yet another preferred embodiment of the fume removal system 20 is shown in a more compact and portable form in FIG. 5. The entire system 20 is contained within an enclosure 66, with the vacuum source 64 located in a lower chamber 94. On the high pressure or exhaust side of the vacuum source 64 is the pump outlet tube 84 leading to the filter 38 and exiting the enclosure through exhaust 42. The lower chamber 94 is preferably insulated to attenuate sound; and the vacuum source 64 is isolated with rubber bushings or the like to reduce vibration. A cooling vent 74 may be provided to adequately cool the vacuum source 64 and prevent overheating. The hair iron 24 with the fume removal device 22 is located in the upper chamber 96, which is readily accessible to the user 68. Although not shown as being connected, tube 76 is a continuous tube that leads from the fume removal device 22 to the intake of the vacuum source 64 below. The tube 76 may be of sufficient length to permit the locating of the enclosure 66 away from the client 70.

While particular forms of the invention have been illustrated and described, it will also be apparent to those skilled in the art that various modifications can be made without departing from the spirit and scope of the invention. Accordingly, it is not intended that the invention be limited except by the claims.

What is claimed is:

1. A fume removal device in connection with a hair iron with a heating element and used in conjunction with a vacuum source during the application of a chemical treatment to the hair; said fume removal device comprising:
at least one fume intake proximate to said heating element;
a fume removal passage in fluid communication between said fume intake and said vacuum source;
said fume intake configured to draw in at least some fumes generated by the localized heating of a section of said hair as said hair iron is applied to said section;
said fume removal passage configured to transport the fumes to a desired location.

2. The fume removal device of claim 1 wherein said fume intake is configured to provide a vacuum flow along at least substantial majority of a length of said heating element.

3. The fume removal device of claim 2 wherein said fume intake is an elongated slot.

4. The fume removal device of claim 3 wherein said elongated slot is longer than said length of said heating element.

5. The fume removal device of claim 2 wherein the rate of said vacuum flow is adjustable to substantially match a rate of fume production.

6. The fume removal device of claim 1 wherein said fume intake is directed towards said section of said hair when said hair iron is applied to said section.

7. The fume removal device of claim 6 wherein said fume intake includes a portion configured to extend over said hair when said hair iron is applied to said section.

8. The fume removal device of claim 1 wherein said desired location is one of a filtration system and atmosphere.

9. The fume removal device of claim 1 wherein said fume removal device is attachable to a standard hair iron.

10. A fume removal system for use during the application of a chemical treatment to the hair; said fume removal system comprising:
a hair iron configured to be applied to a hair strand section;
at least one fume intake provided on said hair iron and configured to be proximate to said hair strand section during application of said hair iron to said hair strand section;
a vacuum source;
a fume removal passage in fluid communication between said fume intake and said vacuum source;
said fume intake configured to draw in a substantial quantity of fumes generated by the localized heating of said hair strand section;
said fume removal passage configured to transport the fumes to a desired location.

11. A fume removal device used during the application of a chemical treatment to the hair; said fume removal device comprising:
a fume intake positioned on a hair iron and in fluid communication with a vacuum source through a fume removal passage;
said fume intake configured to draw in at least some fumes generated by the localized heating of a section of said hair as said hair iron is applied to said section;
said fume removal passage configured to transport the fumes to a desired location.
